(19) United States
(12) Patent Application Publication
(10) Pub. No.: US 2020/0409163 A1
(43) Pub. Date: Dec. 31, 2020

(54) COMPENSATING DISPLAY SCREEN, UNDER-SCREEN OPTICAL SYSTEM AND ELECTRONIC DEVICE

(71) Applicant: SHENZHEN ORBBEC CO., LTD., Shenzhen (CN)

(72) Inventors: Liang ZHU, SHENZHEN (CN); Peng YANG, SHENZHEN (CN); Xing XU, SHENZHEN (CN)

(21) Appl. No.: 17/016,252

(22) Filed: Sep. 9, 2020

Related U.S. Application Data
(63) Continuation of application No. PCT/CN2019/092163, filed on Jun. 21, 2019.

(30) Foreign Application Priority Data
Sep. 17, 2018 (CN) 201811082123.9

(51) Int. Cl. G02B 27/42; G02B 5/18; G02F 1/31

(52) U.S. Cl. CPC G02B 27/4205; G02F 1/31; G02B 5/1866

(57) ABSTRACT

A compensating display screen, an optical system, and an electronic device are provided. The compensating display screen includes: a transparent display screen, comprising a plurality of periodically arranged pixel units for display; and a compensating element, configured to compensate a diffraction effect of the transparent display screen, so that when a preset light beam is incident on the compensating display screen, the same preset light beam is emitted from the compensating display screen. An optical system, comprises the above compensating display screen, and an optical module configured to receive a light beam from the transparent display screen or emit a light beam outward through the transparent display screen. An electronic device, comprises the above optical system, and a filter unit disposed between the transparent display screen and the optical module, and configured to reduce passage of visible light from the transparent display screen.

### CROSS-REFERENCE TO RELATED APPLICATION

The application is a continuation application of International Patent Application No. PCT/CN2019/092163, filed with the China National Intellectual Property Administration (CNIPA) on Jun. 21, 2019, and entitled “COMPENSATING DISPLAY SCREEN, UNDER-SCREEN OPTICAL SYSTEM AND ELECTRONIC DEVICE”, which is based on and claims priority to and benefit of Chinese Patent Application No. 201811082123.9, filed with the CNIPA on Sep. 17, 2018. The entire contents of all of the above-identified applications are incorporated herein by reference.

### TECHNICAL FIELD

This specification relates to the technical field of electronics, and in particular, to a compensating display screen, an under-screen optical system, and an electronic device.

### BACKGROUND

Currently, photographing and displaying are essential functions of many electronic devices, and both a front camera and a display are disposed on the front side of an electronic device to meet various needs such as selfie, content display, and touch interaction.

As people are imposing higher aesthetic requirements on mobile phones, full-screen electronic devices, such as full-screen mobile phones, have gradually become a new trend of innovation of mobile phones, because full-screen mobile phones have a very high screen-to-body ratio, which are easy to control and have a highly aesthetic appearance. Currently, the development of full-screen electronic devices is challenged by the conflict between the front camera and the display screen. The existence of the front camera makes it difficult for the display screen to cover the entire front side of the mobile phone to achieve a high screen-to-body ratio.

A full screen can be achieved by disposing the optical module on the rear side of the display screen. The display screen is located on the front side for displaying an image. A light beam received or emitted by the optical module passes through the display screen. However, as the display screen includes a plurality of pixel units arranged periodically in the transverse direction and the longitudinal direction and the plurality of pixel units constitutes a periodic pixel diffraction structure, the display screen produces a diffraction effect on the incident light beam, eventually resulting in deterioration of the projection or imaging quality of the optical module disposed on the rear side of the display screen.

### SUMMARY

To solve the technical problem in existing technologies that a light beam passing through the display screen experiences a diffraction which affects the projection or imaging quality, this specification provides a compensating display screen including a transparent display screen and a compensating element. The transparent display screen includes a plurality of periodically arranged pixel units for display. The compensating element is configured to compensate a diffraction effect of the transparent display screen, so that when a preset light beam is incident on the compensating display screen, the same preset light beam is emitted from the compensating display screen.

In some embodiments, the compensating element includes a diffractive optical element or a spatial light modulator.

In an embodiment, the diffractive optical element includes at least two diffractive optical sub-elements.

In some embodiments, the compensating element is designed by performing the following steps: obtaining diffraction performance of the transparent display screen; performing an inverse diffraction calculation on the preset light beam based on the diffraction performance to obtain a complex amplitude spatial distribution of an incident light beam that enters the transparent display screen; and calculating a diffraction pattern of the compensating element based on the complex amplitude spatial distribution and the preset light beam.

This specification further provides an optical system, including a transparent display screen that has a plurality of periodically arranged pixel units for display, an optical module, and a compensating element. The optical module is configured to receive a light beam from the transparent display screen or emit a light beam outward through the transparent display screen. The compensating element is disposed between the transparent display screen and the optical module, and configured to compensate a diffraction effect of the transparent display screen, so that when the light beam is passed through the transparent display screen and the compensating element, the same light beam is emitted from the transparent display screen and the compensating element.

In some embodiments, the compensating element includes a diffractive optical element.

In an embodiment, the diffractive optical element includes at least two diffractive optical sub-elements.

In some embodiments, the diffractive optical element is integrated in the transparent display screen.

In some embodiments, the compensating element includes a spatial light modulator.

This specification further provides an electronic device including the optical system described in the above embodiments. Compared with existing technologies, the compensating display screen provided in this specification has the following advantages. A compensating element compensating a diffraction effect of a transparent display screen is provided to offset the diffraction effect caused by a light beam passing through a periodic pixel diffraction structure of the transparent display screen, so that when a preset light beam is incident on the compensating display screen, the same preset light beam is emitted from the compensating display screen, thereby avoiding a diffraction impact of the transparent display screen on the incident light beam and improving the quality and effect of imaging or projection.

### BRIEF DESCRIPTION OF THE DRAWINGS

To describe the technical solutions in the embodiments of this specification more clearly, the following briefly describes the accompanying drawings required for describing the embodiments. Apparently, the accompanying drawings in the following description show merely some embodiments of this specification, and a person of ordinary skill in the art may still derive other drawings from the accompanying drawings without creative efforts.

FIG. 1 is a schematic of front view of an electronic device, according to an embodiment of this specification.

FIG. 2 is a schematic diagram of structural composition of an electronic device, according to an embodiment of this specification.

FIG. 3 is a schematic structural diagram of an under-screen optical system, according to a first embodiment of this specification.

FIG. 4 is a schematic structural diagram of an under-screen optical system, according to a second embodiment of this specification.

FIG. 5 is a schematic structural diagram of an under-screen optical system, according to a third embodiment of this specification.

FIG. 6 is a schematic structural diagram of an under-screen optical system, according to a fourth embodiment of this specification.

FIG. 7 is a schematic structural diagram of an under-screen optical system, according to a fifth embodiment of this specification.

FIG. 8 is a schematic structural diagram of an under-screen optical system, according to a sixth embodiment of this specification.

FIG. 9 is a schematic structural diagram of an under-screen optical system, according to a seventh embodiment of this specification.

FIG. 10 is a schematic structural diagram of an under-screen optical system, according to an eighth embodiment of this specification.

FIG. 11 is a schematic structural diagram of an under-screen optical system, according to a ninth embodiment of this specification.

FIG. 12 is a schematic diagram of an electronic device including a spliced display screen, according to an embodiment of this specification.

### DETAILED DESCRIPTION OF THE INVENTION

To make the objectives, technical solutions, and advantages of this specification clearer and more comprehensible, the following further describes this specification in detail with reference to the accompanying drawings and embodiments. It should be understood that the specific embodiments described herein merely explain this specification but do not limit this specification.

It should be noted that when a component is described to be “fixed on” or “disposed on” another component, the component may be directly or indirectly on the another component. When a component is described to be “connected to” another component, the component may be directly or indirectly connected to the another component. Orientation or position relationships indicated by the terms such as “top,” “bottom,” “left,” and “right” are based on orientation or position relationships shown in the accompanying drawings, and are used only for ease of description, rather than indicating or implying that the mentioned apparatus or element needs to have a particular orientation or needs to be constructed and operated in a particular orientation. Therefore, such terms should not be construed as limitation to this specification. The terms “first” and “second” are merely for description, and are not an indication or implication of relative importance or implicit indication of a quantity of technical features. “A plurality of” means two or more, unless otherwise definitely limited.

To describe the technical solutions of this specification, the following describes the technical solutions in detail with reference to the specific accompanying drawings and embodiments.

FIG. 1 is a schematic front view of an electronic device, according to an embodiment of this specification. The electronic device 10 includes a housing 105, a display screen 106 disposed on the front side, and a sensor disposed on the top. The sensor on the top may include a light emitting module 101, a camera 102, and a light receiving module 103, and may further include a speaker, an ambient light/proximity sensor 104, and so on. The display screen 106 may be a plasma display screen, a liquid crystal display (LCD), a light-emitting diode (LED) display screen, an organic light-emitting diode (OLED) display screen, or the like, and may be configured to display an application image, fill in light, or the like, and may also be any other forms of display screen as actually required. The display screen 106 may also include a touch control function, for example, a capacitive touch electrode disposed in the display screen 106 to serve as a human-machine interaction input apparatus.

A plurality of sensors may be disposed on the top, in other parts, or scattered in different parts of the electronic device. In some embodiments, the sensors may also be disposed on the rear side of the electronic device.

The sensors are configured to send or receive external information of the electronic device, such as illumination information and sound information. For example, the camera 102 may be a visible light camera (color camera or grayscale camera), and is configured to collect an image of an external object. The speaker is configured to convert an electrical signal into a sound signal and send the sound signal out. The ambient light sensor is configured to obtain intensity information of external ambient light. The proximity sensor is configured to detect whether an external object is approaching the electronic device. In addition, the emitting module 101 and the light receiving module 103 may form a depth camera module configured to collect depth image information of the external object. Understandably, the sensors are not limited to sensors of the foregoing types, and different types of sensors may be disposed in the electronic device as actually required. For example, in an embodiment, the sensors further include a floodlighting module or the like.

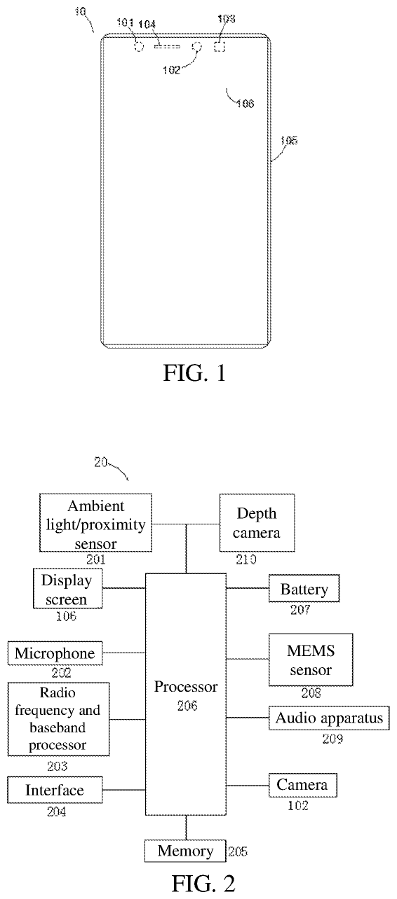

FIG. 2 is a schematic diagram of structural composition of an electronic device, according to an embodiment of this specification. The electronic device further includes a microphone 202, a radio frequency and baseband processor 203, an interface 204, a memory 205, a battery 207, a microelectro mechanical system (MEMS) sensor 208, an audio apparatus 209, and a processor 206 connected to the above components, in addition to the display screen 106 and the sensors shown in FIG. 1 such as the ambient light/proximity sensor 201, the camera 102, and the depth camera 210. Data transmission and signal communication may be implemented between different units through circuit connection. Herein, a compositional structure in one embodiment is described as an example. In other embodiments, the electronic device may include fewer structures or include more other compositional structures. The electronic device may be a mobile phone, a computer, a game console, a tablet, a television set, a wearable device, a smart watch, or the like.

The processor 206 is configured to perform overall control on the entire electronic device. The processor 206 may be a single processor or may include a plurality of processing units, for example, may include processing units having different functions. In some embodiments, the processor 206 may also be an integrated system on chip (SOC) which includes a central processing unit, an on-chip memory, a controller, and a communication interface. In some embodiments, the processor 206 may be an application processor such as a mobile application processor, and is mainly responsible for implementing other functions in the electronic device except a communication function such as text processing and image processing.

The display screen 106 is configured to display an image under control of the processor 206 to render applications and the like to a user. In addition, the display screen 106 may also include a touch control function. In this case, the display also serves as a human-machine interaction interface for receiving user input.

The microphone 202 is configured to receive voice information, and may be configured to implement voice interaction with the user.

The radio frequency and baseband processor 203 is responsible for the communication function of the electronic device, for example, receiving and translating signals such as a voice signal or a text signal to implement information exchange between remote users.

The interface 204 is configured to enable connections between the electronic device and the outside to further implement functions such as data transmission and power transmission. The interface 204 is controlled by a communication interface in the processor 206. The interface 204 may include a USB interface and a WiFi interface.

The memory 205 is configured to store data such as application data, system data, and temporary code and data stored by the processor 206 during execution. The memory 205 may include one or more memories, and may be a random access memory (RAM), a flash memory, or any other form of memory that can be used to store data. Understandably, the memory may be a part of the electronic device, or may exist independently of the electronic device, for example, a cloud memory. The data stored in the memory may communicate with the electronic device through the interface 204 or the like. The application, such as a face recognition application, is generally stored in a non-volatile readable storage medium. When executing the application, the processor calls a corresponding program from the storage medium to execute the application.

The ambient light/proximity sensor 201 may be an integrated single sensor, or may be a stand-alone ambient light sensor and a stand-alone proximity sensor. The ambient light sensor is configured to obtain illumination information of a current environment in which the electronic device is located. In an embodiment, based on the illumination information, screen brightness can be automatically adjusted to provide a display brightness more comfortable for human eyes. The proximity sensor can detect whether an object is approaching the electronic device, based on this, some functions can be implemented. For example, when the user's face is close enough during answering of a phone call, the touch control function of the screen is turned off to prevent accidental touch. In some embodiments, the proximity sensor can also quickly determine an approximate distance between the face and the electronic device.

The battery 207 is configured to provide electricity. The speaker 209 is configured to implement voice output.

The MEMS sensor 208 is configured to obtain current status information of the electronic device, such as location, direction, acceleration, and gravity. Therefore, the MEMS sensor 208 may include sensors such as an accelerometer, a gravimeter, and a gyroscope. In an embodiment, the MEMS sensor 208 may be configured to activate some face recognition applications. For example, when the user picks up the electronic device, the MEMS sensor 208 can acquire this change and transmit this change to the processor 206 at the same time. The processor 206 calls the face recognition application in the memory to perform the face recognition application.

The camera 102 is configured to collect an image. In some applications, for example, when a selfie application is executed, the processor controls the camera 102 to collect an image and transmits the image to the display for displaying. In some embodiments, for example, in an unlocking program based on face recognition, when the unlocking program is activated, the camera collects an image, and the processor processes the image such as performing face detection and recognition, and performs an unlocking task according to a recognition result. The camera 102 may be a single camera or a plurality of cameras. In some embodiments, the camera 102 may include an RGB camera and a grayscale camera that are configured to collect visible light information, and may also include an infrared camera and an ultraviolet camera that are configured to collect invisible light information. In some embodiments, the camera 102 may include a light field camera, a wide-angle camera, and a telephoto camera.

The camera 102 may be disposed at any position of the electronic device, for example, located on the top or at the bottom of a front surface (that is the same surface on which the display is located), a rear surface, or other positions. In the embodiment shown in FIG. 1, the camera 102 is disposed on the front of the electronic device to collect a face image of the user. The camera 102 may also be disposed on the rear surface to photograph a scene or the like. In an embodiment, the camera 102 is disposed on the front surface and the rear surface. The two cameras may collect images independently or may be controlled by the processor 102 to collect images synchronously. In some embodiments, the camera 102 may also be a part of the depth camera 210, for example, serve as a light receiving module or a color camera in the depth camera 210.

The depth camera 210 includes the light emitting module 101 and the light receiving module 103 that are respectively responsible for signal emission and reception of the depth camera. The depth camera may also include a depth calculation processor configured to process the received signal to obtain depth image information. The depth calculation processor may be a special-purpose processor such as an ASIC chip, or may be the processor 206 in the electronic device. For example, for a structured light depth camera, the light emitting module 101 and the light receiving module 103 may be an infrared laser speckle pattern projector and a corresponding infrared camera, respectively. The infrared laser speckle pattern projector is configured to emit a preset speckle pattern of a specific wavelength to a surface of a spatial object. The preset speckle pattern is reflected by the surface of the object and imaged in the infrared camera. In this way, the infrared camera can obtain an infrared speckle image modulated by the object. Further, the infrared speckle image is calculated by the depth calculation processor to generate a corresponding depth image. Generally, a light source in the projector may be a near-infrared light source with a wavelength such as 850 nm or 940 nm. Types of light sources may include an edge-emitting laser, a vertical-cavity surface-emitting laser, or a corresponding light source array. Distribution of speckles in the preset speckle pattern is randomly distributed to realize sub-regions irrelevance along a specific direction or a plurality of directions. That is, any sub-region selected along a specific direction meets a relatively high uniqueness requirement. Optionally, in some embodiments, the light emitting module 101 may also include light sources such as an LED and laser that can emit visible light, ultraviolet light, or other wavelengths, and may be configured to emit structured light patterns such as stripes, speckles, and two-dimensional codes.

In some embodiments, the depth camera may also be a time of flight based (TOF-based) depth camera, a binocular depth camera, or the like. For the TOF-based depth camera, the light emitting module is configured to emit pulsed beams or modulated (such as amplitude modulated) continuous wave beams to the outside. After the light receiving module receives a beam reflected by an object, the circuit of the processor calculates a time interval between the beam emission and the beam reception to further calculate depth information of the object. For the binocular depth camera, a type of binocular depth camera is an active binocular depth camera including one light emitting module and two light receiving modules. The light emitting module projects a structured light image onto the object. The two light receiving modules obtain two structured light images. The processor directly uses the two structured light images to calculate a depth image. Another type of binocular depth camera is a passive binocular depth camera, in which the light emitting module may be referred to as one of the two light receiving modules. The two light receiving modules collect two images. The processor directly uses the two images to calculate a depth image. Subsequently, conception of this specification is described by using a structured light depth camera as an example. Understandably, the corresponding invention content can also be applied to other types of depth cameras.

Referring to FIG. 1 again, to maximize a screen-to-body ratio of the electronic device, the sensor may be disposed on the rear side of the display screen in this specification. In the display screen 106, a region corresponding to the sensor can still display content normally just like other regions. The sensor can pass through the display screen to send or receive a signal, for example, pass through the display screen to perform floodlighting, structured light projection, image acquisition, and the like. Compared with existing technologies, this specification avoids a disadvantage of low reliability of a lifting structure and a disadvantage of poor experience brought by an anomalous screen. Understandably, disposing the sensor on the rear side of the display screen 106 not only advantageously increases the screen-to-body ratio, but also solves other problems, such as a problem of poor experience caused by human eyes focusing on the screen instead of the camera during a video call. Therefore, FIG. 1 only schematically shows a front view of an electronic device. The electronic device may also have other shapes and screen-to-body ratios, for example, the shape of a circle, an oval, or a prism.

However, disposing the sensor (the following will take optical modules such as a light emitting module, a light receiving module, and a camera as examples) on the rear side of the display screen may face some problems, for example, how to hide the sensor to provide the user with perfect full-screen experience, and how to overcome impact on light emission and light reception (including impact on a beam amplitude and phase) caused by the display screen. The optical module is configured to receive or emit light beams of a specified wavelength or wavelength range. In this specification, optical modules are categorized into visible light optical modules and invisible light optical modules. A visible light optical module is configured to emit or receive a visible light beam. An invisible light optical module is configured to emit or receive an invisible light beam. To facilitate understanding, an infrared optical module will be used as an example of the invisible light optical module for description. Understandably, invisible light such as ultraviolet and X-ray is also applicable to this specification.

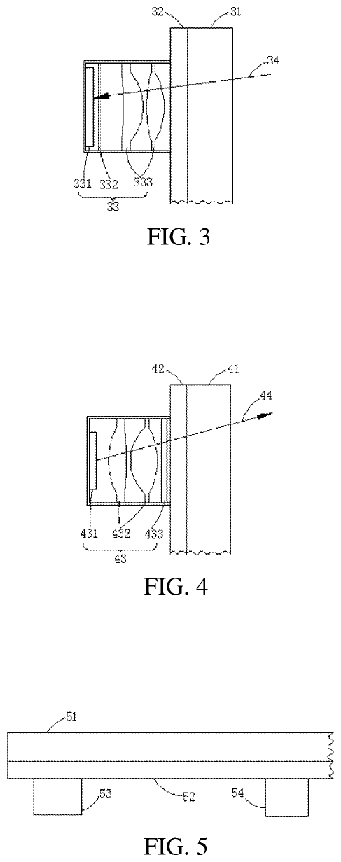

FIG. 3 is a schematic structural diagram of an under-screen optical system, according to a first embodiment of this specification. The under-screen optical system includes a display screen 31 and a light receiving module 33. The light receiving module 33 is disposed on one side of the display screen 31 (for example, on the rear side or at the bottom of the display screen). The display screen 31 includes transparent display screens such as a plasma display screen, an LCD, an LED display screen, and an OLED display screen. The display screen 31 includes a plurality of periodically arranged pixel units for display, such as pixel units periodically arranged along the transverse direction and the longitudinal direction. In order to make the display screen transparent so that the light beam can pass through, the plurality of pixel units may be properly designed. For example, gaps are set between the pixel units, or a part of internal structures of the pixel units are made of transparent materials, so that the display screen can reach a specific aperture ratio, such as a 50% aperture ratio. In some embodiments, all structures of each pixel unit of the display screen may be made of transparent materials to increase transparency.

The light receiving module 33 is configured to receive a light beam 34 from the display screen 31. The light receiving module 33 includes an image sensor 331, a filter element 332, and a lens 333. The image sensor 331 may be a charge coupled device (CCD), a complementary metal-oxide-semiconductor transistor (CMOS), or the like. The filter element 332 may be a Bayer filter, an infrared filter, or the like. The light receiving module may also include other forms of structures such as a light field camera and a photodiode. The lens 333 may be a single lens, or may be a lens group, or a lens array.

FIG. 4 is a schematic structural diagram of an under-screen optical system, according to a second embodiment of this specification. In this embodiment, the under-screen optical system includes a display screen 41 and a light emitting module 43. The light emitting module 43 is disposed on one side of the display screen 41 (such as the rear side or the bottom of the display screen). The display screen 41 is a transparent display screen. The light emitting module 43 disposed on one side of the display screen may emit a light beam 44 outward through the transparent display screen (the emitting outward mentioned herein is only illustrative rather than restrictive). In this embodiment, the light emitting module 43 includes a light source 431, a lens 432, and a diffractive optical element 433. The light source 431 may be an edge-emitting laser, a vertical-cavity surface-emitting laser, an LED, or the like, or may be an array light source including a plurality of sub-light sources such as a vertical-cavity surface-emitting laser array chip. The lens 432 is configured to collimate or focus the light beam emitted by the light source 431. The diffractive optical element 433 receives the light beam from the lens, diffracts the light beam, and then projects a patterned light beam such as a patterned structured light beam (such as a spot pattern or a speckle pattern). In some embodiments, the light emitting module 43 may also be a floodlight illuminator, such as a floodlight illuminator including a light source and a diffuser. In some embodiments, the light emitting module 43 may also be a flash. In some embodiments, the light emitting module may also be a light source in a TOF camera or a proximity sensor or the like, and is configured to emit pulsed or modulated light beams.

In the embodiments shown in FIG. 3 and FIG. 4, in an under-screen optical system that includes a display screen and an optical module (including a light emitting module and a light receiving module), filter units 32 and 42 may be further disposed between the display screen and the optical module. The filter units 32 and 42 may be configured to reduce transmission of visible light from one side of the display screen. In this way, an user cannot directly see the optical module behind the display screen. Therefore, the appearance of the display screen is complete for a better visual aesthetic.

In an embodiment, the filter unit is an optical switch such as a liquid crystal shutter (a liquid crystal spatial light modulator). When powered off, the filter unit is in a non-transparent state that does not allow light to pass through. When powered on, the filter unit is in a transparent state that allows light to pass through. Therefore, with the optical switch being disposed between the optical module and the display screen, the optical module can be hidden by configuring the optical switch. When the optical module is in operation, the optical switch is set to the transparent state to allow light to pass through. When the optical module is not in operation, the optical switch is set to the non-transparent state to block passage of light. In this way, the user on the one side of the display screen cannot see the optical module disposed on the opposite side of the display screen. The optical switch may also be made of other types of materials, such as an electrochromic material and a thermochromic material. Alternatively, a specific optical structure may be used to control whether to allow light to pass.

In an embodiment, the filter unit is a unidirectional fluoroscopy film. The unidirectional fluoroscopy film maximally allows external light to enter the optical module through the display screen while preventing internal light from passing through the display screen. That is, a surface of the unidirectional fluoroscopy film facing the optical module has a transmittance of visible light lower than a reflectance thereof (for example, the transmittance is 5% to 30%, and the reflectance is 90% to 95%), but a surface of the unidirectional fluoroscopy film facing the display screen has a transmittance of the visible light higher than a reflectance thereof (for example, the transmittance is 60% to 95%, and the reflectance is 5% to 30%). It needs to be noted that if the optical module on one side of the display screen is a visible light receiving module (such as a color camera), the imaging quality will be affected to some extent due to influence of the transmittance. If the optical module on one side of the display screen receives or emits an invisible light beam (such as an infrared beam), that is, when the optical module includes an infrared receiving module (such as an infrared camera) and an infrared emitting module, the corresponding unidirectional fluoroscopy film needs to be configured to have a relatively high transmittance of infrared light. That is, for the infrared receiving module, the surface of the unidirectional fluoroscopy film facing the display screen needs to have a relatively high transmittance of infrared light that is generally higher than a reflectance thereof. For the infrared emitting module, the surface of the unidirectional fluoroscopy film facing the infrared emitting module needs to have a relatively high transmittance of infrared light that is generally higher than a reflectance thereof. For example, the transmittance is 80% to 95% to ensure the quality of imaging or projection. When a unidirectional fluoroscopy film is in use, a unidirectional fluoroscopy film with an appropriate performance is selected for different optical modules.

In an embodiment, the filter unit is a filter configured to block visible light and allow passage of only light beams that fall in a specific invisible light wavelength range. For example, in a case that the optical module on one side of the display screen is an infrared receiving module (such as an infrared camera), an infrared emitting module, or the like, the use of the infrared filter enables the infrared receiving module and the infrared emitting module to collect an infrared image, emit an infrared beam, and prevent passage of visible light, thereby achieving the purpose of hiding the optical module behind the display screen.

In an embodiment, the filter unit is a special filter. The special filter has a low transmittance of visible light, but has a high transmittance of light of a specific invisible light wavelength, such as near-infrared light. In an example, the transmittance of visible light is 10% to 50%, and the transmittance of near-infrared light is 60% to 99%. Outside ambient light passes through the special filter and then irradiates the optical module. After the ambient light is reflected by the optical module, the possibility for the reflected ambient light to pass through the special filter again is greatly reduced, thereby achieving the purpose of hiding the optical module behind the display screen. In addition, because this module has a very high transmittance of near-infrared light, impact on the infrared emitting module and the infrared receiving module is rather limited.

Understandably, the foregoing types of filter units are not a limitation on this specification. Any filter unit that can implement similar functions may be applied to this specification.

Understandably, the filter unit may be an independent optical device, or may be combined with the optical module or the display screen. For example, when the filter unit is in the form of a film, the filter unit may be provided by coating the film on the surface of the display screen or the optical device.

As shown in FIG. 1, in addition to the sensors, other devices such as a circuit and a battery are provided on the rear side of the display screen 106. To hide these devices, the filter unit described above may be applied. In fact, such devices do not need to collect or project light beams outside the display screen. Therefore, non-transparency can be implemented in a more cost-effective way to hide the devices. For example, polymer coatings of non-transparent black or other colors or the like may be applied.

FIG. 5 is a schematic structural diagram of an under-screen optical system, according to a third embodiment of this specification. The under-screen optical system includes a display screen 51, a filter unit 52, and a depth camera. The depth camera includes a light receiving module 53 and a light emitting module 54. The filter unit 52 is disposed between the depth camera and the display screen 51. In an embodiment, the filter unit 52 is an optical switch. When the depth camera is in operation, for example, when a depth camera is started in a face recognition program to collect a depth image of a face outside the display screen, the optical switch is turned on to allow light to pass through. When the image collection ends, the optical switch is turned off to prevent passage of light, so as to hide the depth camera. In an embodiment, both the light receiving module 53 and the light emitting module 54 of the depth camera work in an invisible light band such as an infrared band. For example, the light receiving module is configured to collect a light beam of an 850 nm wavelength while the light emitting module 54 is configured to emit a light beam of an 850 nm wavelength. In this case, the filter may be an 850 nm infrared filter, and is configured to allow passage of a light beam of an 850 nm wavelength and prevent passage of visible light, so as to achieve the purpose of depth imaging and to hide the depth camera.

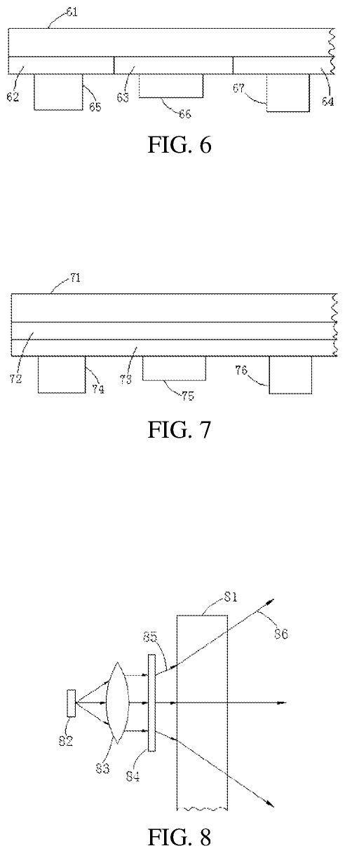

FIG. 6 is a schematic structural diagram of an under-screen optical system, according to a fourth embodiment of this specification. The under-screen optical system includes a display screen 61, a filter unit, and a depth camera. The depth camera includes a light receiving module 65, a camera 66, and a light emitting module 67. The filter unit is disposed between the depth camera and the display screen 61. Generally, the light receiving module 65 and the light emitting module 67 work in an invisible light band and are configured to collect a depth image (the following takes an infrared wavelength as an example for description). That is, the light receiving module 65 and the light emitting module 67 become an infrared receiving module and an infrared light emitting module respectively. The camera 66 is a visible light receiving module, such as a visible light camera configured to collect a visible light image, such as a color image. The filter unit may also be set as an optical switch, a unidirectional fluoroscopy film, a filter, or the like. However, in some embodiments, a single form of filter unit usually cannot meet requirements. Therefore, the filter unit needs to be set as a combination of different forms of filter units. As shown in FIG. 6, the filter unit includes a first filter unit 62, a second filter unit 63, and a third filter unit 64 that correspond to the light receiving module 65, the camera 66, and the light emitting module 67, respectively. This conception is also applicable to the embodiment shown in FIG. 5, that is, the first filter unit and the third filter unit are configured for the light receiving module 53 and the light emitting module 54, respectively. The first filter unit 62, the second filter unit 63, and the third filter unit 64 are arranged along a direction perpendicular to an optical path of the optical module. That is, the first filter unit 62, the second filter unit 63, and the third filter unit 64 are disposed separately, and may be arranged at intervals or contiguously, depending on a position relationship between the receiving module 65, the camera 66, and the light emitting module 67, which is not limited herein.

In an embodiment, the first filter unit 62 and the third filter unit 64 are infrared filters, and the second filter unit 63 is an optical switch or a unidirectional fluoroscopy film.

In an embodiment, the first filter unit 62 is a first unidirectional fluoroscopy film, the third filter unit 64 is a third unidirectional fluoroscopy film, and the second filter unit 63 is an optical switch or a second unidirectional fluoroscopy film. For visible light, surfaces of the first, second, and third unidirectional fluoroscopy films facing the optical module have a transmittance lower than a reflectance thereof, but surfaces facing the display screen 61 have a transmittance higher than a reflectance thereof. For infrared light, a surface of the first unidirectional fluoroscopy film facing the display screen 61 has a transmittance higher than a reflectance thereof, and a surface of the third unidirectional fluoroscopy film facing the light emitting module has a transmittance higher than a reflectance thereof.

In an embodiment, the first filter unit 62 and the third filter unit 64 are optical switches, and the second filter unit 63 is an optical switch or a unidirectional fluoroscopy film.

Understandably, the solutions of this specification are not limited to the above embodiments. Any reasonable combinations of filter units are applicable herein.

FIG. 7 is a schematic structural diagram of an under-screen optical system, according to a fifth embodiment of this specification. Unlike the embodiments shown in FIG. 3 to FIG. 6, at least two layers of filter units are disposed between the optical module and a display screen 71. Understandably, different optical modules may correspond to filter units having different number of layers. Some optical modules may have a single layer of filter units, and some optical modules may have a plurality of layers of filter units. In this embodiment, two-layer filter units are used as an example for description. The depth camera includes a light receiving module 74, a camera 75, and a light emitting module 76. Filter units are disposed between the depth camera and the display screen 71. The filter units include a first filter unit 72 and a second filter unit 73 superimposed along a direction from the optical module to the display screen (along a light beam direction). For example, the first filter unit 72 is an optical switch, and the second filter 73 is a unidirectional fluoroscopy film.

The above embodiments provide solutions for hiding the optical module on the rear side of the display screen.

The display screen generally includes a plurality of pixel units arranged periodically in the transverse direction and the longitudinal direction. The plurality of pixel units constitute a periodic pixel diffraction structure. Therefore, the display screen produces a diffraction effect on the incident light beam, eventually resulting in deterioration of the quality of projection or imaging.

FIG. 8 is a schematic structural diagram of an under-screen optical system, according to a sixth embodiment of this specification. The under-screen optical system includes a display screen 81 and a light emitting module. The light emitting module includes a light source 82, a lens 83, and a first diffractive optical element (DOE) 84. The lens 83 is configured to collimate or focus a light beam emitted by the light source 82. The first diffractive optical element 84 receives the light beam from the lens, and then projects a first diffracted light beam 85. The first diffracted light beam 85 is projected to an external space through the display screen 81. The lens 83 may also be a lens group, a lens array, or the like. Understandably, the light emitting module herein is not limited to the composition described above. For example, the light emitting module may only include the light source 82 and the first DOE 84, or the light emitting module may further include other devices such as a microlens array. Overall, the light emitting module may have the corresponding structural composition as actual needs.

In conventional technologies, a light emitting module that includes a light source, a lens, and a DOE, is configured to project a patterned light beam such as a structured light patterned light beam (such as a speckle pattern, a stripe pattern, or a two-dimensional pattern), a floodlight beam, a single-spot light beam, or a modulated TOF light beam. When the patterned light beam emitted by the light emitting module is projected outward through the display screen 81, it will be diffracted due to a periodic structure of internal pixels inside the display screen 81. That is, if the light emitting module mentioned in conventional technologies is directly disposed on one side of the display screen, the patterned light beam emitted by the light emitting module will be diffracted again by the display screen. In this case, the display screen 81 is a second diffractive optical element (a second DOE). The light beam that is diffracted twice may affect the patterned light beam, for example, reducing contrast and increasing noise, and may even completely deviate from the patterned light beam. This may bring a huge challenge for placing the optical module behind the screen.

In this embodiment, the first DOE 84 will no longer project a preset patterned light beam (such as a preset speckle patterned light beam), but diffraction effects of the first DOE 84 and the display screen (that is, the second DOE) 81 are comprehensively considered in a design stage to achieve the following purposes: the first DOE 84 receives an incident light beam from a light source and then projects a first diffracted light beam 85, and the first diffracted light beam 85 is diffracted again by the second DOE 81 to project a patterned light beam 86.

In an embodiment, designing the first DOE 84 generally includes the following steps.

A first step is to obtain diffraction performance of the display screen, that is, the second DOE, and the diffraction performance may be described by, for example, using a complex amplitude transmittance function. A possible detection method is to let a plane wave beam enter the display screen from a single angle or a plurality of angles, collect emergent light intensity distribution by using a receiving screen, and measure the diffraction performance of the second DOE by the light intensity distribution.

A second step is to perform inverse diffraction calculation on the patterned light beam 86 based on the diffraction performance of the display screen, that is, the second DOE, so as to obtain complex amplitude spatial distribution of the first diffracted light beam 85.

A last step is to calculate a diffraction pattern of the first DOE based on the complex amplitude spatial distribution of the first diffracted light beam 85 and light beam distribution before the light beam enters the first DOE 84 through the lens 83.

Understandably, this design process is only an example, and any other reasonable design schemes are applicable to this specification.

The first DOE 84 is not limited to a single DOE, but may include a plurality of sub-DOEs, which are not necessarily formed on different optical devices. For example, two sub-DOEs may be formed on surfaces of the same transparent optical device separately.

Alternatively, the first DOE 84 and the second DOE 81 may not be necessarily discrete devices. For example, the first DOE 84 may be formed on the rear side of the display screen, that is, the second DOE 81, to improve an overall integration degree. The display screen 81 usually includes a plurality of layers having different functions. Therefore, to further improve the integration degree, the first DOE may also be integrated into a layer in the display screen 81, or one or more sub-DOE layers of the first DOE 84 may be integrated into a layer of the display screen 81.

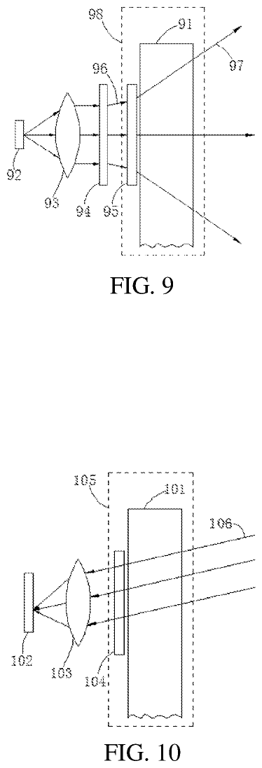

FIG. 9 is a schematic structural diagram of an under-screen optical system, according to a seventh embodiment of this specification. The under-screen optical system includes a display screen 91 and a light emitting module. The light emitting module includes a light source 92, a lens 93, and a first diffractive optical element (DOE) 94. The lens 93 is configured to collimate or focus a light beam emitted by the light source 92. The first diffractive optical element 94 receives the light beam from the lens and then diffracts it to project a patterned light beam 96. The patterned light beam 96 is projected to an external space through the display screen 91. The difference from FIG. 8 is that a compensating element 95 is further disposed between the first DOE 94 and the display screen 91. The compensating element 95 is configured to compensate the diffraction effect of the display screen (a second DOE) 91.

In this embodiment, the compensating element 95 and the second DOE 91 form a new compensating display screen 98. In the compensating display screen 98, the compensating element 95 is designed to compensate the diffraction effect of the display screen, thereby offsetting impact caused by the second DOE 91 on the patterned light beam projected by the light emitting module. That is, after a plane wave beam enters the compensating display screen, an isophase plane of emergent light that exits from the compensating display screen is still perpendicular to a wave vector direction of the incident light. In this way, the patterned light beam that exits from the first DOE 94 enters the compensating display screen, and is then projected into a space as a patterned light beam 97. Understandably, it is difficult for the compensating element 95 to fully eliminate the diffraction effect of the second DOE 91. Therefore, it is difficult to ensure that the patterned light beam 97 is exactly the same as the patterned light beam 96. A slight difference between the two patterned light beams is allowed. For example, a slight difference in the spatial distribution of intensity may exist between the two patterned light beams.

The compensating element 95 may be configured as any optical element that can change an amplitude and/or phase of the light beam, such as a DOE, a spatial light modulator (SLM), or the like. When the compensating element 95 is the spatial light modulator, the compensating element 95 may be a liquid crystal spatial light modulator and may include a plurality of pixels. Each pixel may modulate the amplitude and/or phase of the incident light by changing properties of the pixel (such as a refractive index or a grayscale).

Compared with the embodiment shown in FIG. 8, the design conception of the first DOE 94 in FIG. 9 is the same as that of the conventional light emitting module, and design of the first DOE 84 in the embodiment shown in FIG. 8 is rather more difficult than the conventional design. In the embodiment shown in FIG. 9, the compensating element 95 needs to be primarily designed. In an embodiment, design steps are as follows.

In an embodiment, designing the compensating element 95 generally includes the following steps.

A first step is to obtain diffraction performance of the display screen, that is, the second DOE 91, and the diffraction performance may be described by, for example, using a complex amplitude transmittance function. A possible detection method is to let a plane wave beam enter the display screen from a single angle or a plurality of angles, collect emergent light intensity distribution by using a receiving screen, and measure the diffraction performance of the second DOE 91 by the light intensity distribution.

A second step is to perform inverse diffraction calculation on the emergent light beam 97 based on the diffraction performance of the display screen, that is, the second DOE 91, to obtain complex amplitude spatial distribution of the incident light beam that enters the second DOE 91.

Finally, a last step is to calculate a diffraction pattern of the compensating element 95 based on the complex amplitude spatial distribution of the incident light beam that enters the second DOE 91 and the light beam distribution of the incident light beam 96 that enters the compensating element 95.

In the above steps, the incident light beam 96 that enters the compensating element 95 has almost the same spatial distribution as that of the emergent light beam 97, and may be a plane wave light beam or a patterned light beam.

Understandably, this design process is only an example, and any other reasonable design schemes are applicable to this specification.

In a case that the compensating element 95 is a DOE (denoted by a third DOE 95), the first DOE 94 and the third DOE 95 are not limited to a single DOE, but may include a plurality of sub-DOEs that are superimposed on each other. The plurality of sub-DOEs are not necessarily formed on different optical devices. For example, two sub-DOEs may be formed on surfaces of the same transparent optical device, separately. Alternatively, the first DOE 94 and the third DOE 95 may not be necessarily discrete devices. Two DOEs may be formed on surfaces corresponding to the same transparent optical device respectively, so as to serve as the first DOE 94 and the third DOE 95 respectively. Similarly, the third DOE 95 and the second DOE 91 are not necessarily discrete devices. For example, the third DOE 95 may be formed on one side of the display screen (the second DOE 91) to improve an overall integration degree. Because the display screen usually includes a plurality of layers having different functions, the third DOE 95 may also be integrated into one of the layers of the display screen to further increase the integration degree.

Relative locations of the first DOE 94, the third DOE 95, and the second DOE 91 are not limited to the embodiment shown in FIG. 9. The relative positions between the three DOEs may be designed according to actual requirements. For example, both the first DOE 94 and the third DOE 95 may be integrated into an internal layer structure of the second DOE 91. For example, the location of the first DOE 94 may be interchanged with the location of the third DOE 95. Overall, any structural composition not departing from the conception of this specification is applicable to this specification.

FIG. 10 is a schematic structural diagram of an under-screen optical system, according to an eighth embodiment of this specification. The under-screen optical system includes a display screen 101 and a light receiving module. The light receiving module includes an image sensor 102 and a lens 103. A light beam 106 on the other side of the display screen 101 enters the lens 103 through the display screen 101 and forms an image on the image sensor 102. Due to the periodic microstructure of internal pixels of the display screen, the display screen diffracts the incident light beam 106, thereby affecting the imaging quality. To reduce impact of the diffraction, similarly, in this embodiment, a compensating element 104 is further disposed between the image sensor 102 and the display screen 101. The first DOE 104 is configured to compensate a diffraction effect of the display screen (a second DOE) 101. The first DOE 104 and the second DOE 101 form a new compensating display screen 105. The first DOE 104 in the compensating display screen is designed to compensate the diffraction effect of the display screen, thereby offsetting the impact caused by the second DOE 101 on the imaging quality of the light receiving module.

The first DOE 104 is not necessarily a single DOE, but may be a plurality of sub-DOEs. The plurality of sub-DOEs are not necessarily formed on different optical devices. For example, two sub-DOEs may be formed on surfaces of the same transparent optical device separately. Alternatively, the first DOE 104 and the second DOE 101 may not be necessarily discrete devices. For example, the first DOE 104 may be formed on one side of the display screen (the second DOE 101) to improve an overall integration degree. The display screen 101 usually includes a plurality of layers having different functions. Therefore, to further improve the integration degree, the first DOE 104 may also be integrated into a layer in the display screen 101, or one or more sub-DOE layers of the first DOE 104 may be integrated into a layer of the display screen 101.

In the process described in the embodiments shown in FIG. 8 to FIG. 10, the diffraction effect is primarily expounded, and hiding the optical module is not described. In actual design, it is usually necessary to consider both the diffraction effect and hiding the optical module. Therefore, in the embodiments shown in FIG. 8 to FIG. 10, a filter unit is added between the optical module and the display screen, so as to hide the optical module, which also falls within the protection scope of this specification. For the embodiments herein, reference may be made to the embodiments shown in FIG. 3 to FIG. 7. Specific embodiments are not described in detail herein. However, understandably, parts in the optical module, the filter unit, and the display screen may be integrated with each other during the overall design. For example, for the under-screen light emitting module shown in FIG. 8, the diffractive optical element may be integrated into an inner layer of the display screen, and the filter unit may be disposed between the lens and the DOE. Further description is given below with reference to embodiments.

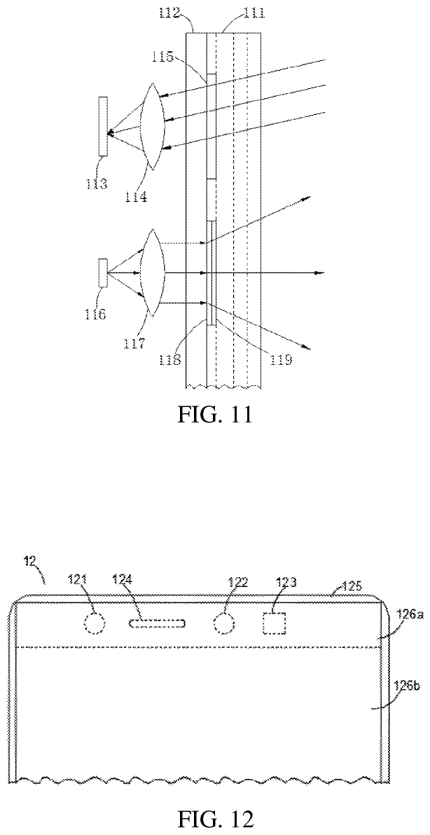

FIG. 11 is a schematic structural diagram of an under-screen optical system, according to a ninth embodiment of this specification. The under-screen optical system includes a depth camera and a compensating display screen 111. The depth camera includes a light receiving module and a light emitting module. The light receiving module includes an image sensor 113 and a lens 114. The light emitting module includes a light source 116, a lens 117, and a first DOE 118. The compensating display screen 111 includes a plurality of layers and a compensating element integrated in the layers, and the first DOE 118 is also integrated in the layers. The compensating element in this embodiment includes a first sub-DOE 115 corresponding to the light receiving module, and a second sub-DOE 119 corresponding to the light emitting module. The first sub-DOE 115 and the second sub-DOE 119 are disposed separately, and diffraction effects of the first sub-DOE 115 and the second sub-DOE 119 both compensate the diffraction effect of the display screen 111, respectively. At least one of the first sub-DOE 115 or the second sub-DOE 119 may be integrated in the display screen 111. A filter unit 112 is disposed between the light receiving module and the display screen 111, and between the light emitting module and the display screen 111.

Understandably, when the light receiving module and the light emitting module are combined with the display screen to form an under-screen depth camera, a structural form of the light receiving module and the display screen as well as a structural form of the light emitting module and the display screen may be arbitrarily configured according to actual requirements, and are not limited to the embodiment shown in FIG. 11. For example, a structure of the light emitting module and the display screen 81 shown in FIG. 8 as well as a structure of the light receiving module and the display screen 101 shown in FIG. 10 may be combined into an under-screen depth camera.

Referring to FIG. 9 or FIG. 10 again, in the compensating display screen, when the compensating elements 95 and 104 are liquid crystal spatial light modulators, the compensating elements have a function of modulating an amplitude and a phase of an incident light beam, which can not only be used for diffraction compensation, but also can be served as an optical switch to hide the light emitting module or the light receiving module. That is, if the light emitting module and the light receiving module are currently in a non-operating state, the liquid crystal spatial light modulator is adjusted to be in a non-transparent state, so as to hide the optical module behind the screen. If the light emitting module and the light receiving module are currently in an operating state, the liquid crystal spatial light modulator is adjusted to be in a transparent state, and phase modulation is performed on pixel units to compensate diffraction effects on an emergent or incident light beam caused by the display screen 91 or 101. This can greatly improve functional and structural integration degrees of the system.

In each of the foregoing embodiments, disposing an optical module behind the display screen requires that light can pass through the display screen, that is, the display screen is a transparent display screen. However, a transparent display screen is more costly than a conventional non-transparent display screen. To solve this problem, this specification provides a spliced display screen solution based on the foregoing embodiments.

FIG. 12 is a schematic diagram of an electronic device including a spliced display screen, according to an embodiment of this specification. The electronic device 12 includes a housing 125, a display screen 126 disposed on the front side, and a sensor. The sensor includes a light emitting module 121, a camera 122, and a light receiving module 123, and may further include a speaker and a sensor 124 such as an ambient light/proximity sensor. The difference from the embodiment shown in FIG. 1 is that the display screen 126 includes two parts, a first display screen unit 126a and a second display screen unit 126b. The sensor is disposed behind the first display screen unit 126a. The first display screen unit 126a is a transparent display screen, and allows the sensor behind the first display screen unit to receive external information or transmit information outward. The second display screen unit 126b is set to have different properties than the first display screen unit 126a.

In an embodiment, the second display screen unit 126b is a non-transparent display screen, such as a common LCD display screen or a common LED display screen. The two display screen units are spliced to form a whole display screen 126.

In an embodiment, the first display screen unit 126a and the second display screen unit 126b are the same type of display screens. For example, both are OLED display screens, but an aperture ratio of the first display screen unit 126a is higher than that of the second display screen unit 126b, which makes it easier for light to pass through. Understandably, in this case, the entire display screen 126 is not necessarily formed by splicing, but the same display screen may have two regions, and aperture ratios of the two regions are controlled during design and manufacturing. Alternatively, besides the aperture ratio, other types of settings may be controlled, for example, a resolution difference between the two regions. A resolution of the first display screen unit 126a is lower than that of the second display screen unit 126b. Alternatively, the two regions are made of materials of different transparency. Overall transparency of the material of the first display screen unit 126a is higher than that of the material of the second display screen unit 126b, thereby ultimately making the transparency of the first display screen unit 126a higher than that of the second display screen unit 126b.

In an embodiment, the display screen 126 includes more than two display screen units. For example, one first display screen unit 126a is configured for each sensor. Shapes of the first display screen unit 126a and the second display screen unit 126b are not limited to the form shown in FIG. 12. For example, the first display screen unit 126a may be circular, and the second display screen unit 126b has a circular through-hole that fits the first display screen unit 126b, and the two display screen units together form a whole display screen 126.

In an embodiment, the first display screen unit 126a and the second display screen unit 126b are controlled independently. When the sensor behind the first display screen unit 126a operates, the first display screen unit 126a is in an off state, and the second display screen unit 126b can still display content normally.

It may be understood that to make the sensor behind the first display screen unit 126a meet the requirement of sending or receiving a signal, all the solutions of the foregoing embodiments may be applied to this spliced screen solution.

The foregoing descriptions are merely exemplary embodiments of this specification, but do not limit this specification. Any modification, equivalent replacement, and improvement made without departing from the spirit and principle of this specification shall fall within the protection scope of this specification.

What is claimed is:

1. A compensating display screen, comprising:
a transparent display screen, comprising a plurality of periodically arranged pixel units for display; and
a compensating element, configured to compensate a diffraction effect of the transparent display screen, so that when a preset light beam is incident on the compensating display screen, the same preset light beam is emitted from the compensating display screen.

2. The compensating display screen according to claim 1, wherein the compensating element comprises a diffractive optical element or a spatial light modulator.

3. The compensating display screen according to claim 2, wherein the diffractive optical element comprises at least two diffractive optical sub-elements.

4. The compensating display screen according to claim 1, wherein the compensating element is designed by:
obtaining diffraction performance of the transparent display screen;
performing an inverse diffraction calculation on the preset light beam based on the diffraction performance to obtain a complex amplitude spatial distribution of an incident light beam that enters the transparent display screen; and
calculating a diffraction pattern of the compensating element based on the complex amplitude spatial distribution and the preset light beam.

5. An optical system, comprising:
a transparent display screen, comprising a plurality of periodically arranged pixel units for display; and
an optical module, configured to receive a light beam from the transparent display screen or emit a light beam outward through the transparent display screen; and
a compensating element, disposed between the transparent display screen and the optical module, and configured to compensate a diffraction effect of the transparent display screen, so that when the light beam is passed through the transparent display screen and the compensating element, the same light beam is emitted from the transparent display screen and the compensating element.

6. The optical system according to claim 5, wherein the compensating element comprises a diffractive optical element.

7. The optical system according to claim 6, wherein the diffractive optical element comprises at least two diffractive optical sub-elements.

8. The optical system according to claim 6, wherein the diffractive optical element is integrated in the transparent display screen.

9. The optical system according to claim 5, wherein the compensating element comprises a spatial light modulator.

10. An electronic device, comprising:
a transparent display screen, comprising a plurality of periodically arranged pixel units for display;
an optical module, configured to receive a light beam from the transparent display screen or a light beam emitted outward through the transparent display screen;
a filter unit, disposed between the transparent display screen and the optical module, and configured to reduce passage of visible light from the transparent display screen; and
a compensating element, disposed between the transparent display screen and the optical module, and configured to compensate a diffraction effect of the transparent display screen, so that when the light beam is passed through the transparent display screen and the compensating element, the same light beam is emitted from the transparent display screen and the compensating element.

11. The electronic device according to claim 10, wherein the filter unit comprises an optical switch, and the optical switch works in a transparent state to allow passage of a light beam, or works in a non-transparent state to block passage of a light beam.

12. The electronic device according to claim 10, wherein the filter unit comprises a unidirectional fluoroscopy film, wherein a surface of the unidirectional fluoroscopy film facing the display screen has a transmittance of visible light higher than a reflectance of visible light, and a surface of the unidirectional fluoroscopy film away from the display screen has a transmittance of visible light lower than a reflectance of visible light.

13. The electronic device according to claim 10, wherein the filter unit comprises a filter, wherein the filter is configured to block visible light and allow passage of light beams that fall in an invisible light wavelength range, or the filter has a transmittance of visible light lower than a transmittance of invisible light.

14. The electronic device according to claim 10, wherein the compensating element comprises a diffractive optical element.

15. The electronic device according to claim 14, wherein the diffractive optical element is integrated in the transparent display screen.

16. The electronic device according to claim 10, wherein the compensating element is designed by:
obtaining diffraction performance of the transparent display screen;
performing an inverse diffraction calculation on the light beam based on the diffraction performance to obtain a complex amplitude spatial distribution of an incident light beam that enters the transparent display screen; and
calculating a diffraction pattern of the compensating element based on the complex amplitude spatial distribution and the light beam.

17. The electronic device according to claim 10, wherein the filter unit and the compensating element are formed by the same spatial light modulator, wherein the spatial light modulator is modulated to a non-transparent state to be used as the filter unit, or the spatial light modulator is modulated to perform modulation on an amplitude or a phase of an incident light beam to be used as the compensating element.

18. The electronic device according to claim 10, wherein the optical module comprises an invisible light receiving module and an invisible light emitting module.

19. The electronic device according to claim 18, wherein the optical module comprises a visible light camera.
